(19) United States
(12) Patent Application Publication
(10) Pub. No.: US 2009/0035500 A1
(43) Pub. Date: Feb. 5, 2009

(54) Container of sustainable materials and having high moisture barrier properties

(75) Inventor: Michael J. Grimm, Sylvania, OH (US)

Correspondence Address: REISING, ETHINGTON, BARNES, KISSELLE, P.C., P.O. BOX 4390, TROY, MI, 48099-4390, US

(73) Assignee: Owens-Ilinois HealthCare Packaging Inc.

(21) Appl. No.: 11/888,550

(22) Filed: Aug. 1, 2007

(51) Int. Cl. B32B 1/08; B29C 69/02

(52) U.S. Cl. 428/35.7; 264/239

(57) ABSTRACT

A prescription vial includes a generally cylindrical body of molded polylactic acid construction and a wrap-around label of polyolefin construction on an exterior surface of the cylindrical body. The cylindrical body with wrap-around label has a moisture vapor transmission rate of not more than 100 mg/day/liter, meeting USP standards for prescription vials. The wrap-around label preferably is of high density polyethylene or polypropylene construction.

The present disclosure relates to a container, particularly a prescription vial, fabricated of sustainable material and having moisture barrier properties that meet or exceed USP standards, and to a method of making such a container.

### BACKGROUND AND SUMMARY OF THE DISCLOSURE

Plastic containers, including particularly prescription vials, typically are fabricated of materials involving non-renewable resources. A general object of the present disclosure is to provide a container, particularly a prescription vial, that is molded of sustainable or renewable materials, and which possesses moisture barrier properties that meet or exceed USP requirements.

The present disclosure embodies a number of aspects that can be implemented separately from or in combination with each other.

A container in accordance with one aspect of the present disclosure includes a container body of molded polylactic acid (PLA) construction and a wrap-around label of polyolefin construction on the container body. The container body with wrap-around label has a moisture vapor transmission rate of not more than 100 mg/day/liter.

A prescription vial in accordance with another aspect of the present disclosure includes a generally cylindrical body of molded polylactic acid construction and a wrap-around label of polyolefin construction on an exterior surface of the cylindrical body. The cylindrical body with wrap-around label has a moisture vapor transmission rate of not more than 100 mg/day/liter, meeting USP standards for prescription vials. The wrap-around label preferably is of high density polyethylene or polypropylene construction.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is an elevational view of a prescription package in accordance with an exemplary embodiment of the present disclosure;

FIG. 2 is a sectional view on an enlarged scale of the portion of FIG. 1 within the area 2; and

FIG. 3 is a sectional view taken substantially along the line 3-3 in FIG. 1.

### DETAILED DESCRIPTION OF PREFERRED EMBODIMENTS

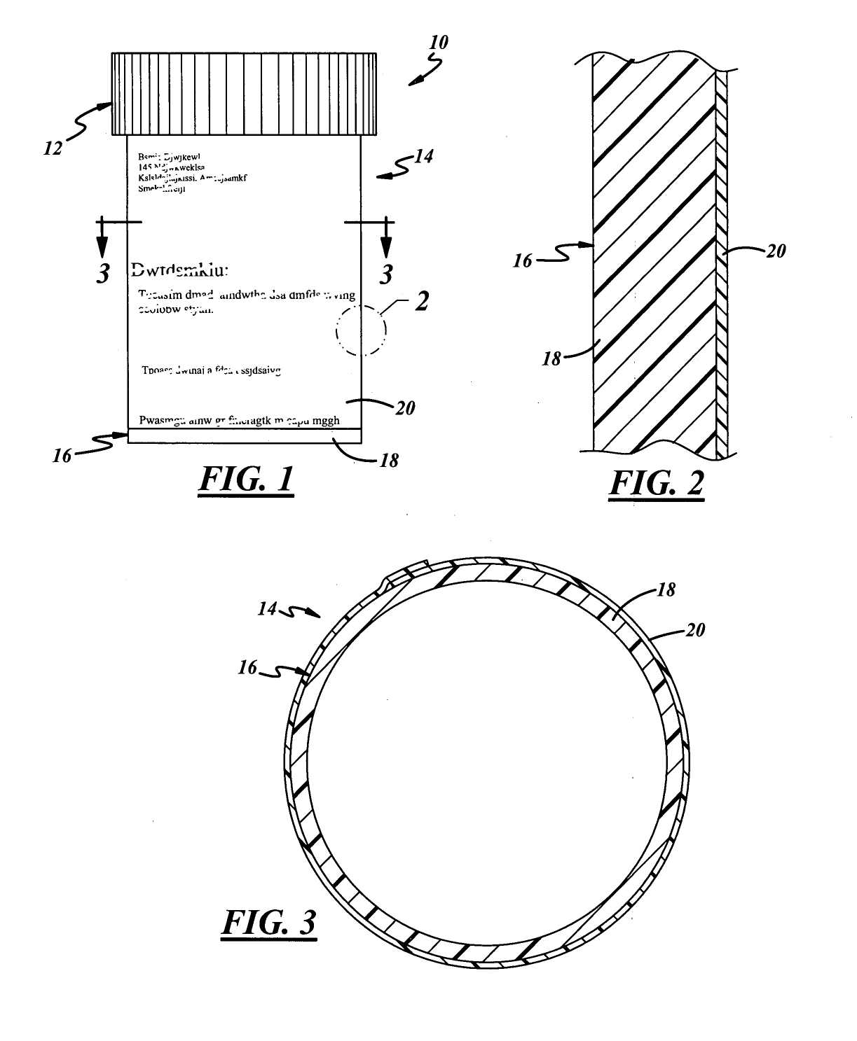

FIG. 1 illustrates a prescription package 10 in accordance with an exemplary embodiment of the present disclosure as including a closure 12 applied to a container, specifically a prescription vial 14. Vial 14 includes a body 16 having a generally cylindrical sidewall 18, a closed bottom and a neck finish designed to receive closure 12. Body 16, including sidewall 18, is of one-piece molded construction, such as injection molded construction. Body 16 preferably is of molded polylactic acid (PLA) construction.

Vial 14 also includes a wrap-around label 20 applied entirely around the exterior surface of sidewall 18, preferably entirely around the exterior surface. Label 20 can have suitable printing or other indicia identifying the contents of the package, specifying a dosage regimen, etc. Label 20 preferably is of monolayer or multilayer polyolefin construction, most preferably of a high moisture barrier material such as high density polyethylene (HDPE) or polypropylene (PP). Whereas container body 16 of PLA material may have a moisture vapor transmission rate of 255 mg/day/liter, which greatly exceeds the USP target of 100 mg/day/liter, application of label 20 reduces the moisture vapor transmission rate to or below the 100 mg/day/liter USP target. The moisture barrier properties of label 20 can be controlled by controlling the thickness of the label. A metallized label having a thin layer of aluminum, for example, could be added to the label further to enhance the moisture vapor transmission properties.

There thus have been disclosed a container, particularly a prescription vial, and a method of making a container that fully satisfy the objects and aims previously set forth. The disclosure has been presented in conjunction with an exemplary embodiment, and modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A container that includes a container body of molded polylactic acid construction and a wrap-around label of polyolefin construction on said container body, said container body with wrap-around label having a moisture vapor transmission rate of not more than 100 mg/day/liter.

2. A prescription vial that includes a generally cylindrical body of molded polylactic acid construction and a wrap-around label of polyolefin construction on an exterior surface of said cylindrical body, said cylindrical body with wrap-around label having a moisture vapor transmission rate of not more than 100 mg/day/liter.

3. The prescription vial set forth in claim 2 wherein said wrap-around label is of high density polyethylene or polypropylene construction.

4. A method of making a container, which includes the steps of
(a) molding a container body of polylactic acid construction and having a cylindrical container sidewall, and
(b) wrapping a label around said container body, said label having at least one layer of polyolefin construction.

5. The method set forth in claim 4 wherein said at least one layer of said label is of high density polyethylene or polypropylene construction.
